(19) United States
(12) Patent Application Publication
(10) Pub. No.: US 2009/0180878 A1
(43) Pub. Date: Jul. 16, 2009

(54) GENERATION OF POWER

(76) Inventor: Astelio Alunni, Randburg (ZA)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/306,560

(22) PCT Filed: Jun. 20, 2007
(86) PCT No.: PCT/IB2007/052365

§ 371 Date: Dec. 24, 2008

(30) Foreign Application Priority Data
Jun. 30, 2006 (ZA) 2006/05425

(51) Int. Cl. F03D 3/02; F03D 11/00

(52) U.S. Cl. 416/132 B; 416/198 R

(57) ABSTRACT

According to one aspect of the present invention, there is provided a turbine including—a plurality of adjacent rotors, —each rotor including a pair of opposed balanced arms, each arm extending on either side of a central axis—the rotors being provided in adjacent array along the central axis with each rotor being provided in its own plane perpendicular to the central axis. Each rotor may include a plurality of hinged panels or vanes. The panels or vanes may have an aerofoil shape to assist in permitting fluid to pass over and between the panels or vanes and to provide an amount of lift because of the aerofoil shape during their upstream cycle. According to another aspect of the present invention, there is provided a method of generating power, including the steps of constructing, erecting, and utilizing a turbine as herein described.

### INTRODUCTION

This invention relates to generation of power. More particularly, this invention relates to a turbine for, and a method of, generating power from wind or water currents ie from fluid currents.

### BACKGROUND TO THE INVENTION

In the state of the art, such turbines, for example wind mills, have been known for many years, either to create energy for pumping water, milling grain, or for generating electric power, or the like. More recently, such devices include rotors that are adapted to change their configuration. This assists rotation of the turbine rotor during its down-wind or power cycle whilst the opposite part of the rotor will transiently adopt a free flow configuration during the up-wind or return cycle.

Such devices also include multiple, stacked rotors, with each rotor having hinged vanes or panels which close to receive the maximum force of the wind on the power or down-wind cycle, and that open to present less resistance to the wind on the up-wind or return cycle. These vanes or panels are simply flat, hinged panels.

One of the disadvantages of such devices is that, at each plane, each rotor consists for example of four arms which present a so-called fluid shadow ie a partial blockage of wind to the down-wind arm during each power cycle thereby restricting the effectiveness of the rotor.

### OBJECTS OF THE INVENTION

It is therefore an object of the present invention to provide an improved turbine and method that overcomes, at least partly, the disadvantages associated with the prior art.

It is also an object of the present invention to provide a new and inventive turbine and method relative to the prior art.

### SUMMARY OF THE INVENTION

According to one aspect of the invention, there is provided a turbine including
a plurality of adjacent rotors,
each rotor including at least one pair of opposed balanced arms, each arm extending on either side of a central axis,
the rotors being provided in adjacent array along the central axis with each rotor provided in its own plane perpendicular to the central axis.

The turbine may therefore include a means or arrangement for reducing so-called “fluid shadow”. When used in this specification and claims, the term “fluid shadow” means the effect that occurs when a turbine consists of more than one rotor provided in the same plane, and an upstream arm causes partial blockage of fluid flow to a downstream arm, resulting in reduced efficiency of the turbine. In other words, the present invention may reduce, at least partly, the aforementioned problem of fluid shadow, and thereby increase the efficiency of the turbine by utilizing fluid flow more efficiently.

Each rotor may include a plurality of hinged panels or vanes. The hinged panels or vanes may be adapted to close when the arm of each rotor moves downsteam by pressure/force of a fluid current, thereby presenting a larger (closed) surface to fluid flow, whilst the panels or vanes hinge to an open configuration during the opposite or upstream cycle, thereby presenting less wind resistance to the fluid flow.

Each adjacent rotor may be disposed at a selected angle to its adjacent rotor.

The selected angle may be determined by the number of rotors provided in the turbine according to a formula being: 180 divided by the number of rotors. For example, if two rotors are provided, the angle between the rotors will be 90° degrees; if three rotors are provided, the angle will be 60° degrees, if four rotors are provided, the angle will be 45° degrees, if five angles rotors are provided, the angle will be 36° degrees; and so on.

Alternatively, and as a variation of the above arrangement, each rotor may be disposed at the same angle as its adjacent rotor.

According to another aspect of the present invention, there is provided a turbine as herein described, each panel or vane having an aerofoil shape. The aforementioned aerofoil shape may assist not only in fluid flow through each arm of the rotor when moving through its upstream cycle but may also, because of the lift generated by fluid flow over the aerofoil shape, assist in moving such arm through the upstream (or return) cycle.

According to yet another aspect of the invention, there is provided a retaining means for retaining the invention in either one of the ground or the sea-bed. The retaining means may consist of a spike to be inserted into the

ground/sea-bed. The retaining means may further consist of articulated legs directed at stabilizing the invention, once the spike is inserted into the sea-bed, for example. The retaining means may yet further have a hammer weight for hammering the spike into the ground or sea-bed, as the case may be.

The aforementioned retaining means may alternatively comprise an anchor attached to the invention via a linkage (such as a rope, cable or chain) for anchoring the invention to a particular area in the sea.

The invention may include a method of generating power, including the steps of constructing, erecting, and utilizing a turbine as herein described.

According to a still further aspect of the present invention, there is provided a method of power generation, including the steps of operating a turbine and utilizing a means or arrangement in the turbine to reduce fluid shadow during such turbine operation.

### DETAILED DESCRIPTION OF THE INVENTION

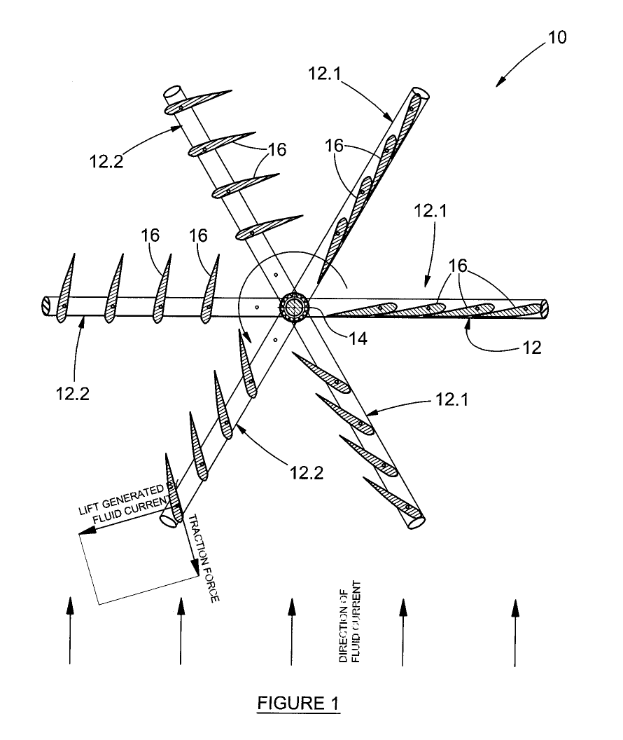

The invention will now be described in greater detail, by way of non-limiting example, with reference to the following drawings, in which: FIG. 1 shows a schematic plan view of a turbine having three rotors, according to one form of the present invention;

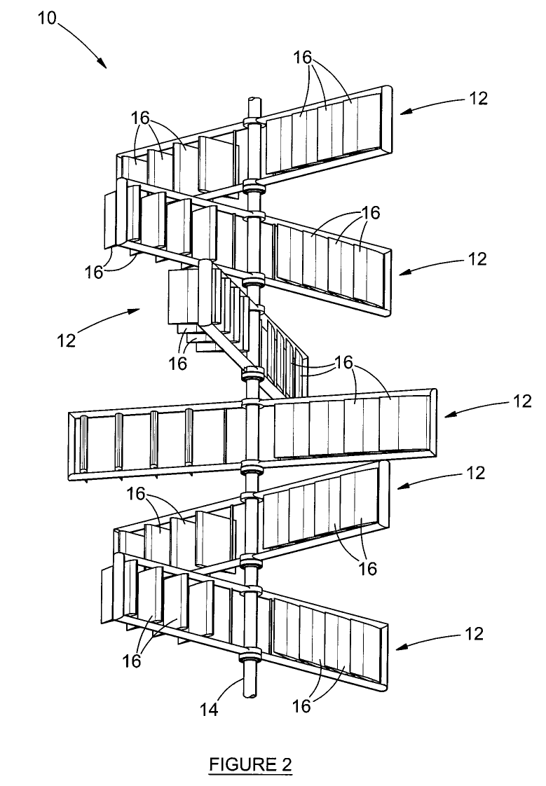

FIG. 2 shows a schematic side perspective view of a second turbine having multiple rotors, according to another form of the present invention;

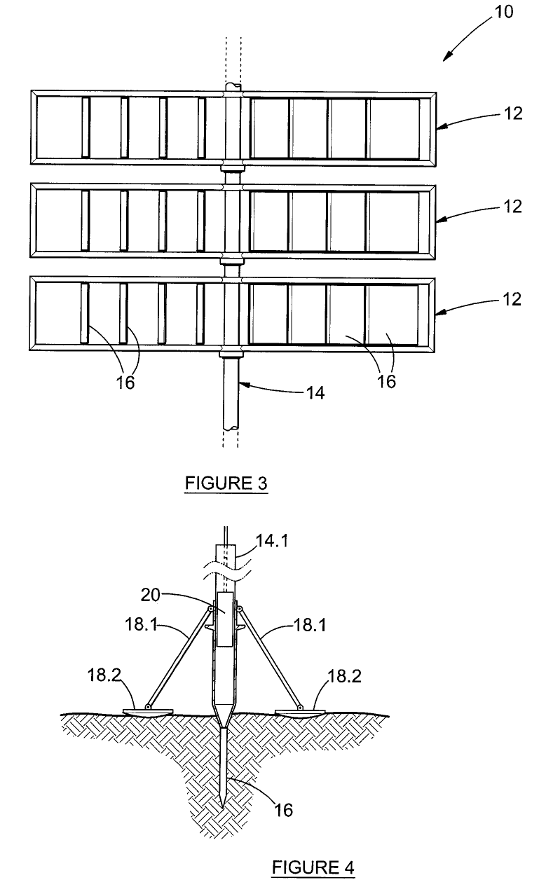

FIG. 3 shows a schematic side view or elevation of a third turbine having multiple rotors, according to yet another form of the present invention; and

FIG. 4 shows a schematic side sectional view of an anchoring arrangement for the turbine shown in the above Figures, according to yet another aspect of the present invention.

In the drawings, like reference numerals refer to like parts, unless otherwise indicated.

Referring firstly to FIG. 1, reference numeral 10 refers generally to a turbine according to one form of the present invention. The turbine 10 includes three rotors 12, each having two straight arms 12.1 and 12.2 extending on either side of a central axis in the form of a rotor shaft 14. On each rotor 12, there is provided a plurality of perpendicular panels or vanes 16 as shown in the drawing. This permits the panels or vanes 16 to hinge to a closed position on the power or downstream cycle, as shown on the rotor arm 12.1 on the right hand side of the drawing, whilst on the opposite rotor arm 12.2, the vanes 16 are shown hinged in an open position. This is caused by the action of a wind or water current ie fluid flow (shown by the unnumbered arrows at the foot of the drawing) on the hinged vanes 16, that will open the vanes 16, as shown in the return or downstream cycle, as the rotor 12 rotates in an anti-clockwise direction, as shown in the drawing. Referring next to FIG. 2, a turbine 10 is shown, having a (greater) number of adjacent rotors 12, each disposed at a suitable angle, as explained above, to its adjacent rotor 12. Each rotor 12 is otherwise as shown in FIG. 1. Referring next to FIG. 3, a compound turbine is shown, being a variation of the turbines shown in FIGS. 1 and 2, and having a number of adjacent rotors 12 each rotor being disposed in the same plane (vertical in the drawing sheet). Each rotor is otherwise as shown in FIG. 1.

It will be seen, especially from FIG. 2, that in the horizontal plane passing through each rotor 12, there is no other rotor located in such plane that can provide a fluid shadow, or a partial fluid shadow, so that each rotor 12 is exposed to the full force of the fluid current acting on it. Such an array of either vertical or horizontal rotors 12 can be highly effective in utilizing fluid currents for purposes of rotating the turbine 10, and hence in generating power.

As appears from FIGS. 2 and 3, each rotor 12 is mounted, and rotates, on an independent set of bearings for easier rotation of each rotor 12.

Although not shown in the drawings, a power take-off (PTO) may be mounted on the shaft 14, having suitable gearing that may be connected to an electrical generator, for example, (also not shown).

As shown in the drawings, more particularly in FIG. 1, each panel or vane 16 may be provided with an aerofoil shape. This shape will assist not only in permitting fluid (for example wind) to pass easily over and between the panels or vanes 16 during their upstream or return cycle but will also provide an amount of lift because of their aerofoil shape during such cycle. This will increase the efficiency of the functioning of the turbine 10.

Referring lastly to FIG. 4, an anchoring arrangement for the turbine shown in either FIG. 2 or FIG. 3 is shown schematically. A central rotor shaft 14.1 inside the rotor 14 terminates in a spike 16 to be inserted or driven into the ground or the seabed. At least two articulated legs 18.1 are arranged around the spike for stabilizing the turbine 10, once inserted into the seabed. Each articulated leg 18.1 has a base plate 18.2 for further stabilization of the turbine 10. A hammer weight 20 of the conventional type may be used, in pile-driving fashion, to drive the spike 16 into the seabed.

In use, the turbine 10 as hereinbefore described, will be constructed and erected, using for example the anchoring arrangement shown in FIG. 4 and as described above, in a position where it will receive sufficient wind or water current flow. The turbine 10 can be erected either vertically with the rotors 12 extending in a vertically stacked array, or in a horizontal array, as is best suited by the circumstances.

The rotor 14 will be suitably connected to an electrical generating set (not shown), and in this way use of the turbine 10 will provide an efficient means of utilizing fluid flow to generate electric power.

The turbine 10 and its component parts will operate in the manner as hereinbefore described, to provide power in a suitable form, as desired.

Although certain forms only of the present invention have been described herein, it will be understood by any person skilled in the art that modifications and/or variations of the invention are possible. For instance, the retaining means may be an anchor attached to the turbine via a linkage as opposed to the spike and hammer weight arrangement described hereinbefore. Such and other modifications and/or variations are therefore to be considered as falling within the spirit and scope of the present invention as herein described and/or claimed.

1-8. (canceled)

9. A turbine comprising:
a plurality of adjacent rotors, wherein each rotor comprises a pair of opposed balanced arms, each arm extending on either side of a central axis the rotors being provided in adjacent array along the central axis with each rotor being provided in its own plane perpendicular to the central axis.

10. The turbine of claim 1, wherein each rotor comprises a plurality of hinged panels or vanes.

11. The turbine of claim 2, wherein the hinged panels or vanes are adapted to hinge to a closed configuration when the arm of each rotor moves downstream by pressure or force of a fluid current, thereby presenting a larger surface to fluid flow, and wherein the panels or vanes hinge to an open configuration during an opposite or upstream cycle, thereby presenting less wind resistance to the fluid flow.

12. The turbine of claim 1, wherein each rotor is disposed at a selected angle to its adjacent rotor.

13. The turbine of claim 12, wherein the selected angle is determined by the number of rotors provided in the turbine according to a formula: 180 divided by the number of rotors.

14. The turbine of claim 1, wherein each panel or vane has an aerofoil shape.

15. A method of generating power comprising constructing, erecting, and utilizing the turbine of claim 1.

16. A method of generating power, including the steps of operating a turbine and utilizing an arrangement in the turbine to reduce fluid shadow during such turbine operation.
